(19) United States
(12) Patent Application Publication
(10) Pub. No.: US 2013/0321389 A1
(43) Pub. Date: Dec. 5, 2013

(54) SYSTEM AND METHOD FOR 3D IMAGING

(71) Applicant: Fredrik Orderud, Oslo (NO)

(72) Inventor: Fredrik Orderud, Oslo (NO)

(73) Assignee: GENERAL ELECTRIC COMPANY, Schenectady, NY (US)

(21) Appl. No.: 13/482,302

(22) Filed: May 29, 2012

(51) Int. Cl. G06T 15/00

(52) U.S. Cl. 345/419

(57) ABSTRACT

A system and method for the three-dimensional visualization of medical images includes superimposing a left eye image polarized in a first orientation and a right eye image polarized in a second orientation. The system and method includes wearing a left contact lens that is polarized in the first direction and a right contact lens that is polarized in the second direction. The system and method includes viewing the left eye image and the right eye image at generally the same time while wearing the left contact lens and the right contact lens.

### FIELD OF THE INVENTION

This disclosure relates generally to a system and method for the three-dimensional visualization of medical images using polarized contact lenses.

### BACKGROUND OF THE INVENTION

The display of three-dimensional (3D) medical data has been fraught with challenges. If the data is viewed on a two-dimensional (2D) display, such an monitor or LCD screen, the 3D data of a volume must be displayed either one slice at a time or as a volume-rendered image. When viewing data one slice at a time, it is easy for the viewer to become “lost” within the data and to not fully understand how all the surrounding anatomical structures are spatially positioned with respect to each other. According to other conventional techniques, 3D data may be rendered, such as by surface or volume-rendering techniques. These renderings involve the use of shading and other techniques to give perspective to the 3D data even though it is being displayed on a 2D screen. While useful, these renderings still have noticeable shortcomings regarding the ability of a user to quickly and accurately understand the relative positioning of a patient's anatomy.

Stereoscopic visualization techniques offer an improvement in the ability of a user to accurately display 3D data. Typical stereoscopic systems display two images of the same object at the same time. Each of the images represents the object at a slightly different angle and may be considered to be a left eye image and a right eye image. According to one conventional technique, the images may be differentially polarized and superimposed upon each other. According to another conventional technique, a processor may control the display to rapidly alternate between the left eye image and the right eye image. According to either of the above-mentioned techniques, the user is required to wear special glasses to insure that the left eye only views the left eye image and that the right eye only views the right eye image. Special glasses are required to view the stereoscopic images generated by conventional stereoscopic systems. For example, polarized lenses may be used to filter the images according to one conventional technique or the special glasses may include rapidly changing shutters that are timed to coincide with the altering of the images according to another conventional technique. While these conventional techniques are successful at providing a stereoscopic representation of 3D data, the reliance upon special glasses is cumbersome and often annoying for the user. In the medical field, it would be extremely beneficial to present medical image data in a stereoscopic manner, particularly to provide guidance for surgeons during an interventional procedure. However, using a conventional stereoscopic display would require the use of the oftentimes large and cumbersome special glasses. Due to the bulkiness, the surgeons would likely be forced to take the special glasses on and off multiple times during a procedure, which is an inconvenience and a distraction. For these and other reasons an improved method and system for the three-dimensional visualization of medical images is desired.

### BRIEF DESCRIPTION OF THE INVENTION

The above-mentioned shortcomings, disadvantages and problems are addressed herein which will be understood by reading and understanding the following specification.

In an embodiment, a method of three-dimensional visualization for medical images includes displaying a left eye image of a medical image that is polarized in a first orientation, displaying a right eye image of the medical image that is polarized in a second orientation that is different from the first orientation, wherein the left eye image and the right eye image are superimposed upon each other. The method includes wearing a left contact lens polarized in the first orientation in a left eye and wearing a right contact lens polarized in the second orientation in a right eye. The method includes viewing the left eye image and the right eye image at generally the same time while wearing both the left contact lens and the right contact lens in order to visualize a stereoscopic representation of the medical image.

In an embodiment, a system for the three-dimensional visualization of medical images includes a display device including a polarizer, a processor in communication with the display device, the processor configured to access image data. The processor is configured to generate a left eye image from a first perspective based on the image data and a right eye image from a second perspective based on the image data. The processor is configured to display a superimposed image on the display device, the superimposed image including the left eye image and the right eye image. The left eye image is polarized in a first orientation by the polarizer and the right eye image is polarized in a second orientation by the polarizer. The system includes a left contact lens that is polarized in the first orientation and configured to be worn in a left eye while viewing the superimposed image. The left contact lens is configured to transmit the left eye image while blocking the right eye image. The system also includes a right contact lens that is polarized in the second orientation and configured to be worn in the right eye while viewing the superimposed image. The right contact lens is configured to transmit the right eye image while blocking the left eye image.

In another embodiment, a system for the three-dimensional visualization of medical images includes a display device including a polarizer, a medical imaging system in communication with the display device. The medical imaging system includes a processor. The processor is configured to access image data from the medical imaging system. The processor is configured to generate a left eye image from a first perspective based on the image data. The processor is configured to generate a right eye image from a second perspective based on the image data. The processor is configured to display the left eye image superimposed with the right eye mage on a 3D-enabled portion of the display device, wherein the left eye image is polarized in a first orientation by the polarizer and the right eye image is polarized in a second orientation by the polarizer. The processor is configured to display additional data that is not superimposed on a 2D-enabled portion of the display device.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram of a system for the three-dimensional visualization of medical images according to an embodiment;

FIG. 2 is a schematic diagram of a system for the three-dimensional visualization of medical images according to an embodiment;

FIG. 3 is a schematic diagram of a sectional view of a contact lens in accordance with an embodiment;

FIG. 4 is a flow chart of a method in accordance with an embodiment; and

FIG. 5 is a schematic diagram of a display device in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

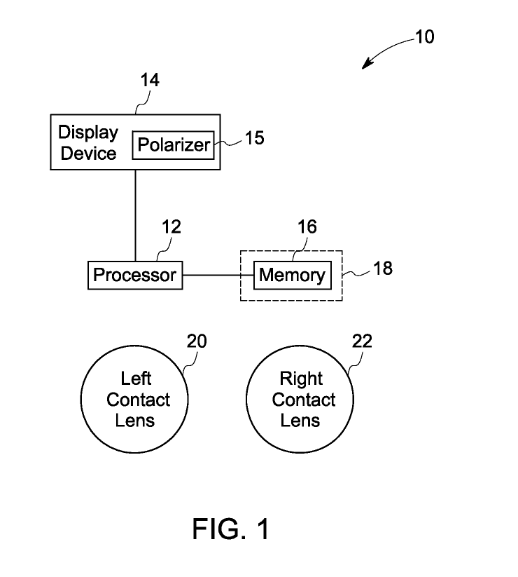

FIG. 1 is a schematic diagram of a system for the three-dimensional visualization of medical images according to an embodiment. The system 10 includes a processor 12, a display device 14 including a polarizer 15, a memory 16, a left contact lens 20 and a right contact lens 22. The processor 12 may be a central processing unit (CPU). The processor 12 may be in communication with the display device 14 and the memory 16 through a hard-wired connection or through wireless techniques. The memory 16 may be volatile, such as RAM, non-volatile, such as ROM, flash memory, etc., or a combination of the two. Left contact lens 20 is polarized in a different configuration than right contact lens 22. According to an embodiment, the left contact lens 20 and the right contact lens 22 may each be linearly polarized in a different generally orthogonal direction. For example, both the left contact lens 20 and the right contact lens 22 may be weighted so that they remain in a generally fixed orientation with respect to the viewer's eye. According to an embodiment, the left contact lens 20 may be polarized in a first direction, such as in a horizontal direction, and the right contact lens 22 may be polarized in a second direction, such as in a vertical direction, that is perpendicular to the first direction. It should be appreciated that horizontal and vertical are just two exemplary orientations. It should be appreciated by those skilled in the art that the left contact lens 20 may be linearly polarized in any direction just so long as the right contact lens 22 is linearly polarized in a direction that is generally perpendicular to the direction of polarization of the left contact lens 20. According to another embodiment, the left contact lens 20 may be circularly polarized, for example in either a clockwise orientation or a counter-clockwise orientation. The right contact lens 22 may be circularly polarized in the other of the clockwise direction and the counter-clockwise direction. For example, if the left contact lens 20 is circularly polarized in a clockwise orientation, the right contact lens 22 would be circularly polarized in a counter-clockwise orientation. Additional details about the system 10 will be described hereinafter.

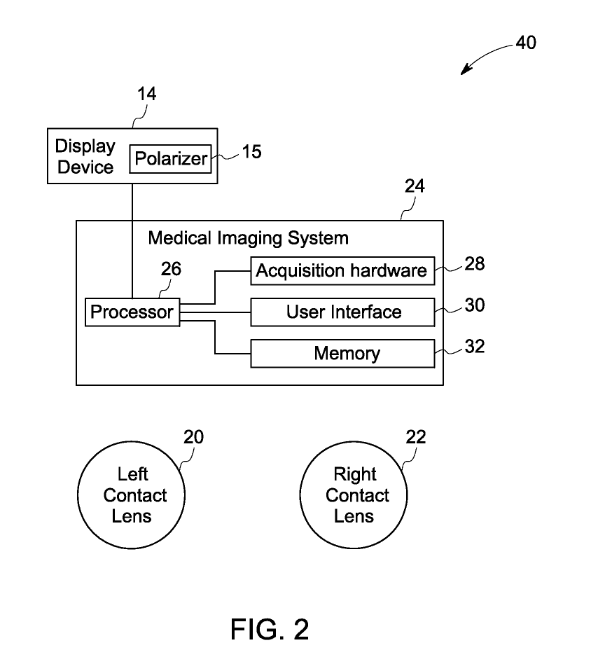

FIG. 2 is a schematic diagram of a system for the three-dimensional visualization of medical images according to another embodiment. Substantially identical components shared between FIGS. 1 and 2 have been labeled with identical reference numbers. In addition to the display device 14 including the polarizer 15, the left contact lens 20 and the right contact lens 22 shared with the system 10 (shown in FIG. 1), the system 40 also includes a medical imaging system 24. The medical imaging system 24 includes a processor 26 connected to acquisition hardware 28, a user interface 30, and a memory 32. The processor 26 may be connected to any one of the display device 14, the acquisition hardware 28, the user interface 30, or the memory 32 through either hard-wired connections or through wireless techniques. Additional details about the system 40 will be provided hereinafter.

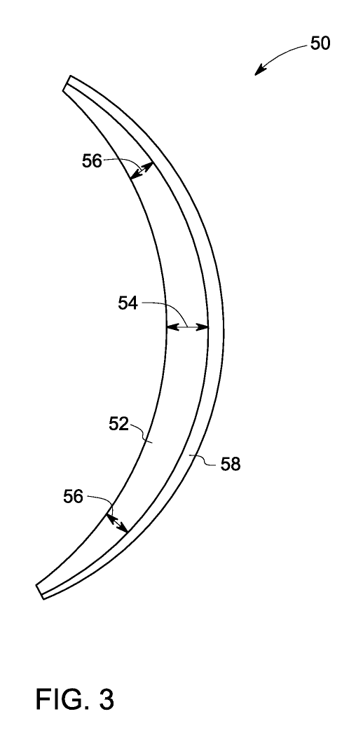

FIG. 3 is a schematic diagram of a sectional view of a contact lens 50 in accordance with an embodiment. The contact lens 50 includes a first layer 52 that may be a plastic, such as polyacrylamide. The first layer 52 may optionally be shaped to provide prescriptive benefit if the wearer is near-sighed (myopic) or far-sighted (hyperopic). For example, according to an embodiment the first layer 52 is thicker at a first location 54, at the center of the contact lens 50 than it is at a second location 56, closer to the edge of the contact lens 50 to provide a prescriptive correction for hyperopia. According to other embodiments, the contact lens may also be shaped to correct for other conditions, including myopia. Also, according to known techniques in the contact lens industry, the contact lens 50 may also be shaped with different corrective powers along different radial axes in order to correct a wearer's astigmatism.

The contact lens 50, also includes a second layer 58. The second layer 58 may, for example, be applied as a coating to the first layer 52. The second layer 58 is polarized and the orientation of the polarization changes depending on whether or not the contact lens 50 is a left contact lens, such as the left contact lens 20 (shown in FIG. 1) or a right contact lens, such as the right contact lens 22 (shown in FIG. 1). According to an embodiment, the second layer 58 may include a quarter-wave plate, configured to pass only right-hand or left-hand polarized light, or a linear polarization layer, configured to pass only light that is polarized in a specific linear direction.

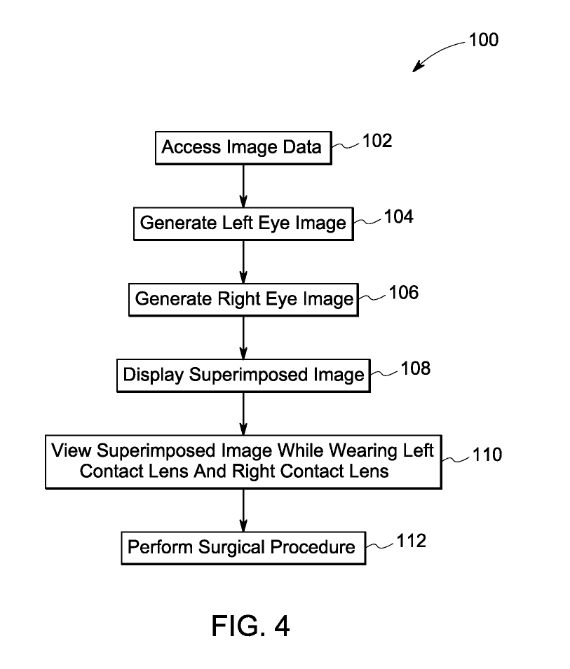

FIG. 4 is a flow chart of a method in accordance with an exemplary embodiment. The individual blocks of the flow chart represent steps that may be performed in accordance with the method 100. Additional embodiments may perform the steps shown in a different sequence and/or additional embodiments may include additional steps not shown in FIG. 4. The technical effect of the method 100 is the visualization of a stereoscopic representation of a medical image while performing a surgical procedure. The method 100 will be described according to an exemplary embodiment where the method 100 is implemented by the processor 26 of the system 40 (shown in FIG. 2).

Referring to both FIGS. 2 and 4, at step 102, the processor 26 accesses image data from a memory 32. The image data may, for example, be acquired with acquisition hardware 28. According to other embodiments, a separate processor may perform the image reconstruction based on the image data and the processor may be located outside the medical imaging system. For example, according to the example shown in FIG. 1, the processor 12 may be part of stand-alone workstation and the memory 16 may be located remotely from the processor 12. For example, the memory 16 may be a component of a picture archiving and communications system (PACS) 18 or the memory 16 may be a component of a separate medical imaging system (not shown).

Referring back to FIGS. 2 and 4, at step 104 the processor 26 generates a left eye image based on the image data. Next, at step 106, the processor 26 generates a right eye image based on the image data. The left eye image and the right eye image need to form a complementary image pair in order to provide stereoscopic viewing for the user. The left eye image and the right eye image both include the same structures from slightly different perspectives or viewing angles. The processor 26 is able to reconstruct images from any hypothetical viewing angle based on the image data. The left eye image may be generated based on a viewing angle that is shifted to the left of the viewing angle used to generate the right eye image. The processor 26 is attempting to simulate the change in viewing angles between the left image and the right image that would naturally exist based on a separation distance consistent with the spacing of a user's right eye and left eye. Most people have a separation of approximately 4 cm to 6 cm between their left and right eyes. The processor 26, may be configured to change the offset between the viewing angles based on the distance of a user to the display device. Or, the processor 26 may assume a standard viewing distance and generate a left eye image and a right eye image with a difference in viewing angle that corresponds to a 4 to 6 cm separation at the standard viewing distance. According to one exemplary embodiment, the change in viewing angles between the left eye image and the right eye may be in the range of 2 degrees to 10 degrees for a typical viewing distances in the range of 50 cm to 100 cm. It should be appreciated by those skilled in the art that the left eye image and the right eye image may be generated based on different viewing angles outside of the aforementioned range according to other embodiments.

Next, at step 108, the processor 26 displays a superimposed image on the display device 14. The superimposed image includes both the left eye image and the right eye image displayed either at the same time or the system could generate the superimposed image by rapidly alternating between displaying the left eye image and the right eye image at a rate of greater than or equal to 15 frames per second. For example, the superimposed image may include the left eye image superimposed upon the right eye image. According to an embodiment, the processor 26 may control the polarizer 15 in the display device 14 to polarize the left eye image in a first orientation and to polarize the right eye image in a second orientation. For example, the processor 26 may control the routing of the left eye image and the right eye image to the polarizer 15. For example, the polarizer 15 may linearly polarize the left eye image in a first orientation, such as horizontally, while the polarizer 15 may linearly polarize the right eye image in a second orientation, such as vertically. It should be appreciated that the left eye image and the right eye image could be linearly polarized in any number of different orientations. However, if linear polarization is used, it is important that the polarization direction of the left eye image and the right eye image are generally perpendicular to each other.

According to a preferred embodiment, the polarizer 15 may circularly polarize the left eye image in a first orientation while the polarizer 15 may circularly polarize the right eye image in second orientation that is opposite of the first orientation. That is, the polarizer 15 may circularly polarize the left eye image in one of a clockwise or a counter-clockwise direction and the polarizer 15 may circularly polarize the right eye image in the other of the clockwise direction and the counter-clockwise direction. For example, the left eye image may be circularly polarized in a clockwise direction while the right eye image is circularly polarized in a counter-clockwise direction or vice versa.

The differential polarization of the left eye image and the right eye image may be accomplished in several different ways that are known to those skilled in the art. For example, projecting an image through a linear polarizer will result in a linearly polarized image, while projecting an image through a quarter-wave plate will result in a circularly polarized image. Therefore, the left eye image may be projected through a first linear polarizer or first quarter-wave plate and the right eye image may be projected through a second linear polarizer or a second quarter-wave plate. The polarizer 15 may include separate polarizers (either linear polarizers or quarter-wave plates) to differentially polarize the left eye image and the right eye image. According to an embodiment, the display device 14 may include two projectors and the polarizer 15 may include a differently oriented polarizing filter on each of the two projectors. The two projectors may then generate the superimposed image by projecting both the left eye image, that is polarized in a first orientation, and the right eye image, that is polarized in a second orientation, at the same time. According to an embodiment, the superimposed image may include the left eye image displayed directly on top of the right eye image. It should be appreciated that the display device 14 and the polarizer 15 may be configured differently according to other embodiments.

According to another embodiment, the display device 14 may generate and display the superimposed image by rapidly alternating between displaying the left eye image through a first polarizing filter and the right eye image through a second polarizing filter. According to another embodiment, the display device may include an active polarizing filter positioned in front of a typical screen in order to control the polarization of the left eye image and the right eye image. The active polarizing filter is required to change its polarization orientation many times per second in synchronization with the display of the left eye image and the right eye image on the display device.

Next, at step 110 of the method 100, the user views the superimposed image while wearing the left contact lens 20 in their left eye and the right contact lens 22 in their right eye. As previously discussed, the left contact lens 20 is polarized in a first orientation that is the same as the left eye image while the right contact lens 22 is polarized in a second orientation that is the same as the orientation of the right eye image. The left contact lens 20 will transmit only the left eye image and the right contact lens 22 will transmit only the right eye image. Therefore, while viewing the superimposed image, the user will see only the left eye image with their left eye and only the right eye image with their right eye. As previously described, the left eye image was generated from a different viewing direction than the right eye image. The difference in the viewing angle between the image presented to the user's left eye and the image presented to the user's right eye allows the user to visualize a stereoscopic, or 3D, representation of the medical image. According to a preferred embodiment, the right contact lens and the left contact lens are circularly polarized. If the user were wearing linearly polarized contact lenses, the effectiveness of the polarizers would be highly dependent upon the angle of the user's head with respect to the display device 14. However, by wearing circularly polarized contact lenses, the orientation of the user's head with respect to the display device 14 is much less important.

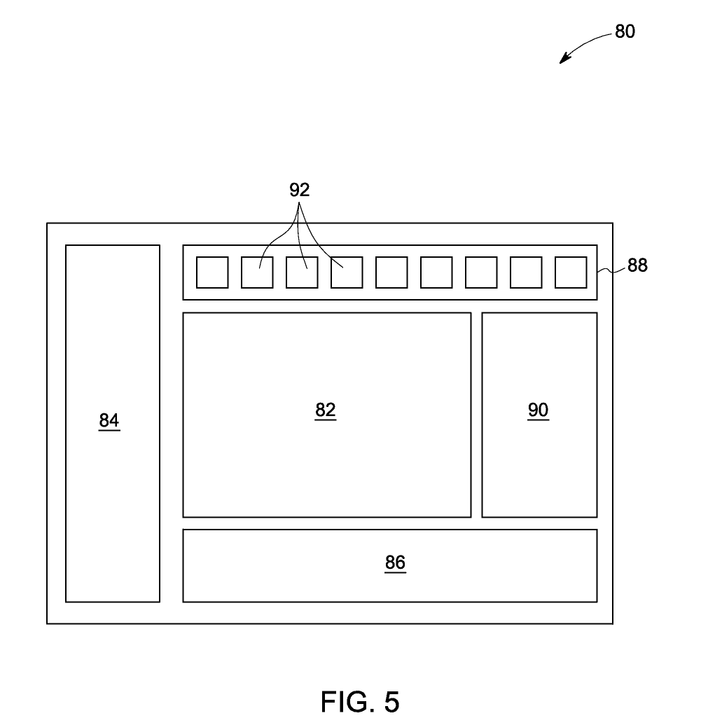

FIG. 5 is a schematic diagram of a display device in accordance with an embodiment. The display device 80 includes a 3D-enabled portion 82 and a plurality of 2D-enabled portions: a first 2D-enabled portion 84, a second 2D-enabled portion 86, a third 2D-enabled portion 88, and a fourth 2D-enabled portion 90. According to an exemplary embodiment, the 3D-enabled portion 82 may display a left eye image superimposed with a right eye image. The first 2D-enabled portion 84 may include patient data, such as name, age, height, weight, gender, etc. The second 2D-enabled portion 86 may include information about the image displayed in the 3D-enabled portion 82. For example, it may include the time the image was acquired, the type of system with which the data was acquired and the like. The third 2D-enabled portion 88 may include information about the view being displayed in the 3D-enabled portion 82. And, the fourth 2D-enabled portion 90, may include a plurality of thumbnails 92. According to an exemplary embodiment, each of the thumbnails 92 represents another image that may be display on the 3D-enabled portion 82. According to other embodiments, the images within the thumbnails may be displayed in part of the 3D-enabled portion, so that the user may visualize them in 3D.

According to an embodiment, the 3D-enabled portion 82 is configured to display images in 3D. That is, the 3D-enabled portion 82 is configured to display a superimposed image including a left eye image and a right eye image so that a user may visualize a stereoscopic representation of the medical image. The 2D-enabled portions, on the other hand, are configured to only display 2D data because it is typically easier for a user to view textual data in a 2D format instead of a 3D format. However, in accordance with an embodiment, the user may selectively configure the size, shape and location of the 3D-enabled portion 82. Likewise, the user may selectively configure the size, shape and location of the 2D-enabled portions. According to embodiments, multiple 3D-enabled portions may be enabled and a different number and/or layout of 2D-enabled portions may be configured on the display device 80.

Next, at step 112, the user perform a surgical procedure while using the stereoscopic representation of the medical image for reference. Any type of surgical procedure may be performed with the method 100. However, according to an exemplary embodiment, the method 100 may be used for cardiac procedures such as mitral valve repair and cardiac ablation. The stereoscopic representation of the medical image provides a detailed three-dimensional representation of the anatomy of the patient. Details involving the spatial relationship between various anatomical structures are easily and quickly interpreted from the stereoscopic representation of the medical image. Since the user is wearing polarized contact lenses, he/she does not have to deal with the bulky and cumbersome special glasses that are typically required in order to view stereoscopic images. According to the method 100, the user may rely on the stereoscopic representation of the medical image for guidance during a surgical procedure. The user may, therefore, shift his or her focus back and forth between the stereoscopic representation of the medical image and the patient during the surgical procedure. By using polarized contact lenses, instead of conventional glasses, it is much more comfortable and convenient for the user to perform the intended procedure. The polarized contact lenses offer a much wider field-of-view than special glasses. Having a wide field-of-view is beneficial for a surgeon to maintain situational awareness during an interventional procedure. Additionally, the user will not be put in the awkward position of constant putting on and removing the special glasses throughout the procedure. By using polarized contact lenses, the user is able to obtain all the benefits of a three-dimensional image with the comfort, field-of-view, and visual clarity enabled by not wearing any extra glasses. Additionally, if the user requires a vision correction, the polarized contacts can easily be manufactured to correct any vision problems at least as well as existing prescription contacts lenses or glasses. As a further benefit to users requiring a prescription, the user would only be required to wear a single pair of contact lenses instead of both contact lenses and the special glasses or instead of both regular prescription glasses and the special glasses required for stereoscopic viewing.

According to an exemplary embodiment, the medical imaging system 24 (shown in FIG. 2) may be an ultrasound imaging system. According to other embodiments, the medical imaging system 24 may be selected from a group including a computed tomography system, a magnetic resonance tomography system, and an X-ray imaging system. It should be appreciated by those skilled in the art that the image data may include ultrasound data, computed tomography data, magnetic resonance tomography data and X-ray data depending upon the type of imaging system that was used to acquire the data. Since it is possible to acquire 3D ultrasound data in real-time or to acquire a live 3D image (i.e. 4D ultrasound), ultrasound data is particularly well-suited for real-time imaging during a surgical procedure. By acquiring 3D ultrasound data in real-time and displaying a real-time stereoscopic representation of the resulting image, a user may use the stereoscopic representation of the image during the process of the interventional procedure to make real-time adjustments during the surgical procedure. According to another embodiment, a live three-dimensional image may be generated in real-time during the process of acquiring image data. The live three-dimensional image is updated in real-time as data of the structures is acquired. Viewing the live three-dimensional image is similar to watching a movie of the structure as it moves in real-time. This is of course very useful for real-time feedback during a procedure. As already noted, the stereoscopic representation of the image provides excellent spatial information of the image. As such, the stereoscopic representation is extremely helpful for guiding a user/surgeon to the target tissue with an absolute minimum amount of collateral damage to surrounding tissue. Additionally, the user can see a 3D representation of the anatomy during the procedure, thus making it easy to ensure that all of any potentially problematic tumors, cysts, nodes, etc. have been removed as well as helping to insure that no healthy tissue is damaged.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method of three-dimensional visualization for medical images comprising:
displaying a left eye image of a medical image that is polarized in a first orientation;
displaying a right eye image of the medical image that is polarized in a second orientation that is different from the first orientation, wherein the left eye image and the right eye image are superimposed upon each other;
wearing a left contact lens polarized in the first orientation in a left eye;
wearing a right contact lens polarized in the second orientation in a right eye; and
viewing the left eye image and the right eye image at generally the same time while wearing both the left contact lens and the right contact lens in order to visualize a stereoscopic representation of the medical image.

2. The method of claim 1, wherein the left eye image and the left contact lens are linearly polarized in a first direction, and the right eye image and the right contact lens are linearly polarized in a second direction that is generally perpendicular to the first direction.

3. The method of claim 1, wherein left eye image and the left contact lens are circularly polarized in one of a clockwise direction and a counter-clockwise direction, and the right eye image and the right contact lens are circularly polarized in the other of the clockwise direction and the counter-clockwise direction.

4. The method of claim 1, further comprising using the stereoscopic representation of the medical image for reference during the process of performing a surgical procedure.

5. The method of claim 4, wherein the surgical procedure comprises a cardiac procedure.

6. The method of claim 1, wherein the medical image is generated from one of ultrasound data, computed tomography data, magnetic resonance tomography data, and X-ray data.

7. A system for the three-dimensional visualization of medical images comprising
a display device including a polarizer;
a processor in communication with the display device, the processor configured to access image data, the processor configured to generate a left eye image from a first perspective based on the image data and a right eye image from a second perspective based on the image data, the processor configured to display a superimposed image on the display device, the superimposed image including the left eye image and the right eye image, wherein the left eye image is polarized in a first orientation by the polarizer and the right eye image is polarized in a second orientation by the polarizer;
a left contact lens that is polarized in the first orientation and configured to be worn in a left eye while viewing the superimposed image, wherein the left contact lens is configured to transmit the left eye image while blocking the right eye image; and
a right contact lens that is polarized in the second orientation and configured to be worn in the right eye while viewing the superimposed image, wherein the right contact lens is configured to transmit the right eye image while blocking the left eye image.

8. The system of claim 7, wherein the processor is configured to access the image data from a picture archiving and communications system.

9. The system of claim 7, wherein the left contact lens and the right contact lens both include a linear polarization layer.

10. The system of claim 9, wherein the left contact lens is linearly polarized in a first direction and the right contact lens is linearly polarized in a second direction that is different from the first direction.

11. The system of claim 7, wherein the left contact lens and the right contact lens both include a quarter-wave plate.

12. The system of claim 11, wherein the left contact lens is circularly polarized in one of a clockwise direction and a counter-clockwise direction and the right contact lens in circularly polarized in the other of the clockwise direction and the counter-clockwise direction.

13. A system for the thee-dimensional visualization of medical images comprising:
a display device including a polarizer;
a medical imaging system in communication with the display device,
the medical imaging system including a processor,
wherein the processor is configured to:
access image data from the medical imaging system;
generate a left eye image from a first perspective based on the image data;
generate a right eye image from a second perspective based on the image data;
display the left eye image superimposed with the right eye image on a 3D-enabled portion of the display device, wherein the left eye image is polarized in a first orientation by the polarizer and the right eye image is polarized in a second orientation by the polarizer; and
display additional data that is not superimposed on a 2D-enabled portion of the display device;
a left contact lens polarized in the first orientation and configured to be worn in a left eye while viewing the display device; and
a right contact lens polarized in the second orientation and configured to be worn in a right eye while viewing the display device.

14. The system of claim 13, wherein the medical imaging system comprises an ultrasound imaging system, a computed tomography system, a magnetic resonance imaging system, or an X-ray system

15. The system of claim 13, wherein the processor is further configured to generate and display a live three-dimensional image on the 3D-enabled portion of the display device.

16. The system of claim 13, wherein the processor is further configured to display the left eye image superimposed on the right eye image in real-time as the medical imaging system acquires the three-dimensional data.

17. The system of claim 13, wherein the processor is configured to adjust the size and orientation of the 2D-enabled portion of the display device in response to a user input.

18. The system of claim 13, wherein the processor is configured to display an image, a thumbnail, text, or portions of a user interface within the 2D-enabled portion of the display device.

19. The system of claim 17, wherein the processor is configured to adjust the position of the 2D-enabled portion of the display device to any position on the 2D display device.

20. The system of claim 17, wherein at least one of the contact lenses is shaped to provide a prescriptive correction for myopia or hyperopia.
